(19) United States
(12) Patent Application Publication
(10) Pub. No.: US 2012/0139516 A1
(43) Pub. Date: Jun. 7, 2012

(54) Power supply circuit with adaptive input selection and method for power supply

(75) Inventors: Kuo-Chen Tsai, Hsinchu City (TW); Wei-Hsin Wei, Zhubei City (TW)

(73) Assignee: Richtek Technology Corporation, R.O.C.

(21) Appl. No.: 13/135,377

(22) Filed: Jul. 1, 2011

(30) Foreign Application Priority Data
Dec. 2, 2010 (TW) 099141881

(51) Int. Cl. G05F 1/10

(52) U.S. Cl. 323/282

(57) ABSTRACT

The present invention discloses a power supply circuit with adaptive input selection and a method for power supply. The power supply circuit includes: a charge pump for receiving at least one voltage and generating a boosted voltage; a first buck switching regulator coupled to a battery, for operating at least one first power transistor to convert a battery voltage to an output voltage according to a first control signal; a second buck switching regulator coupled to the charge pump, for operating at least one second power transistor to convert the boosted voltage to the output voltage according to a second control signal; and a controller generating the first control signal or the second control signal according to a level of the voltage of the battery, to select the first buck switching regulator or the second switching regulator for generating the output voltage.

### CROSS REFERENCE

The present invention claims priority to TW099141881, filed on Dec. 2, 2010.

### BACKGROUND OF THE INVENTION

1. Field of Invention

The present invention relates to a power supply circuit with adaptive input selection, in particular to a power supply circuit that can adaptively selects its input according to a battery voltage. The present invention also relates to a power supply method with adaptive input selection.

2. Description of Related Art

FIG. 1 shows a schematic diagram of a prior art power supply circuit which generates an output voltage Vout from a battery and supplies the output voltage to a load, wherein the load is, for example, a display panel of a portable electronic device. As shown in the figure, the power supply circuit essentially includes two converters: a buck switching regulator 11 and a boost switching regulator 12. The buck switching regulator 11 receives a battery voltage and switches at least one power transistor therein to convert the battery voltage to a lower voltage Vcc which is not higher than the output voltage Vout. The voltage Vcc is supplied through a wire in a printed circuit board (PCB) which has an equivalent resistance represented by Rpcb, and it drops to Vcc−ΔV. The boost switching regulator 12 switches at least one power transistor therein to convert the voltage Vcc−ΔV to the output voltage Vout so that the output voltage Vout can be stable. The reason for the prior art to use both the buck switching regulator and the boost switching regulator is because, in the beginning, the battery voltage is higher than the output voltage, but after the battery supplies power for a certain while, the battery voltage will decrease to a level lower than the output voltage Vout. Therefore, the buck switching regulator 11 is required for converting the battery voltage to the voltage Vcc having a steady level, so that the boost switching regulator 12 can generate the output voltage Vout from the voltage Vcc under any condition of the battery voltage.

In the foregoing prior art power supply circuit, the power switching regulator 11 can be a synchronous or asynchronous buck switching regulator as shown in FIGS. 2A-2B, and the boost switching regulator 12 can be a synchronous or asynchronous boost switching regulator as shown in FIGS. 2C-2D.

In the circuit structure of the prior art power supply circuit, the boost switching regulator 12 is required, but the boost switching regulator consumes more power than the buck switching regulator. In addition, because the wiring in a PCB is becoming narrower, the power consumption of the equivalent resistance Rpcb becomes significant. Thus, it is an important task to reduce the power consumption so as to extend the battery life

In the view of above, the present invention proposes a power supply circuit with adaptive input selection, in which an input voltage is selected according to the battery voltage to optimize the operation of the power supply circuit.

### SUMMARY OF THE INVENTION

An objective of the present invention is to provide a power supply circuit with adaptive input selection.

Another objective of the present invention is to provide a power supply method with adaptive input selection.

To achieve the foregoing objectives, in one perspective of the present invention, it provides a power supply circuit with adaptive input selection, comprising: a charge pump receiving at least one voltage and generating a boosted voltage; a first buck switching regulator coupled to a battery, for operating at least one first power transistor to convert a voltage of the battery to an output voltage according to a first control signal; a second buck switching regulator coupled to the charge pump, for operating at least one second power transistor to convert the boosted voltage to the output voltage according to a second control signal; and a controller generating the first control signal or the second control signal according to a level of the voltage of the battery, to select the first buck switching regulator or the second switching regulator for generating the output signal.

In the foregoing power supply circuit, the first buck switching regulator and the second buck switching regulator preferably share at least one power device. In one preferable embodiment, the first buck switching regulator includes the first power transistor, a lower gate transistor and an inductor which are coupled to a same node, and the second buck switching regulator includes the second power transistor, the lower gate transistor and the inductor which are coupled to the same node.

In another preferable embodiment, the first buck switching regulator includes the first power transistor, a diode and an inductor which are coupled to a same node, and the second buck switching regulator includes the second power transistor, the diode and the inductor which are coupled to the same node.

In the foregoing power supply circuit, the charge pump may receive the at least one voltage directly or indirectly from the battery.

In another preferable embodiment, the charge pump generates the boosted voltage by adding multiple voltages, or generates the boosted voltage as a fixed or variable multiple of one voltage. For example, the charge pump may add the voltage of the battery with another voltage, to generate the boosted voltage.

In the foregoing power supply circuit, when the output voltage is generated by the first buck switching regulator, the charge pump may be disabled to reduce power consumption.

In another perspective of the present invention, it provides a power supply method with adaptive input selection, comprising: receiving a battery voltage; converting the battery voltage to an output voltage when the battery voltage is higher than a threshold voltage; receiving at least one voltage and generating a boosted voltage when the battery voltage is not higher than the threshold voltage; and converting the boosted voltage to the output voltage.

In the foregoing method, the step of converting the battery voltage to an output voltage and the step of converting the boosted voltage to the output voltage preferably share at least one power device.

In one preferable embodiment, the step of receiving at least one voltage and generating a boosted voltage is achieved by a charge pump which generates the boosted voltage by adding multiple voltages, or generates the boosted voltage as a fixed or variable multiple of one voltage.

In another preferable embodiment, when the battery voltage is higher than the threshold voltage, the charge pump is disabled.

The objectives, technical details, features, and effects of the present invention will be better understood with regard to the detailed description of the embodiments below, with reference to the drawings.

### BRIEF DESCRIPTION OF THE DRAWINGS

FIG. 1 shows a schematic diagram of a prior art power supply circuit.

FIGS. 2A-2B show a synchronous and an asynchronous buck switching regulator, respectively.

FIGS. 2C-2D show a synchronous and an asynchronous boost switching regulator, respectively.

FIG. 3 shows an embodiment according to the present invention.

FIG. 3A shows an embodiment for detecting a level of the battery voltage according to the present invention.

FIG. 4 shows another embodiment of the present invention.

FIG. 5 shows yet another embodiment of the present invention.

FIG. 5A shows an embodiment of the present invention, wherein the battery voltage is one of the inputs of the charge pump.

FIG. 6 shows another embodiment of the present invention.

FIG. 7 shows a still other embodiment of the present invention.

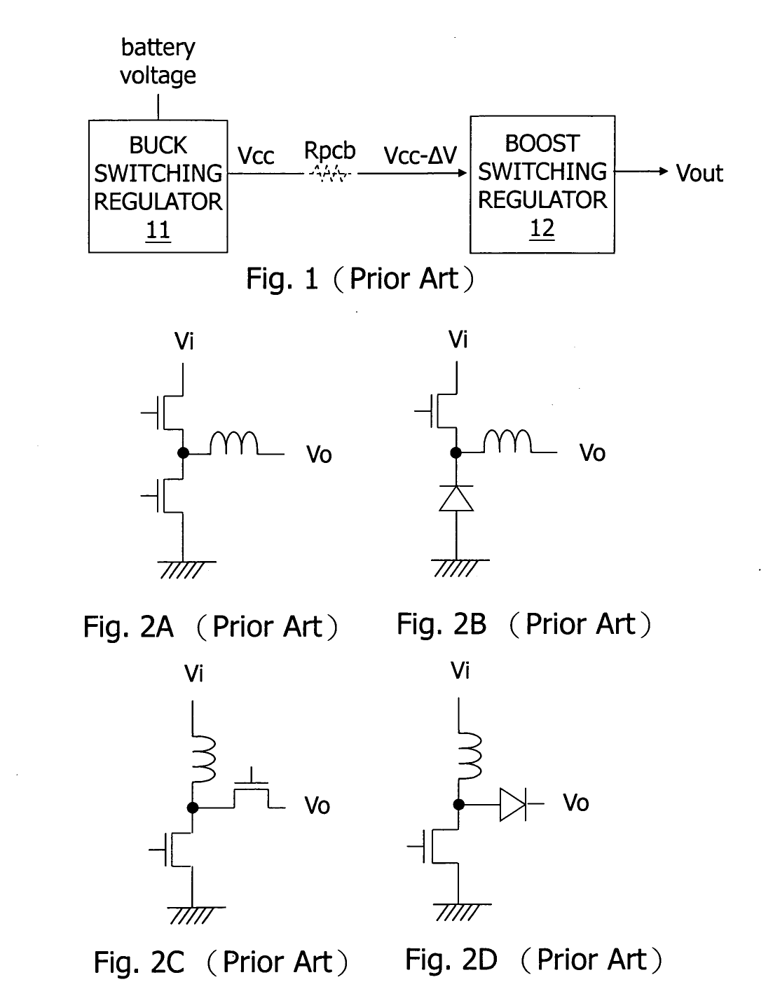

### DESCRIPTION OF THE PREFERRED EMBODIMENTS

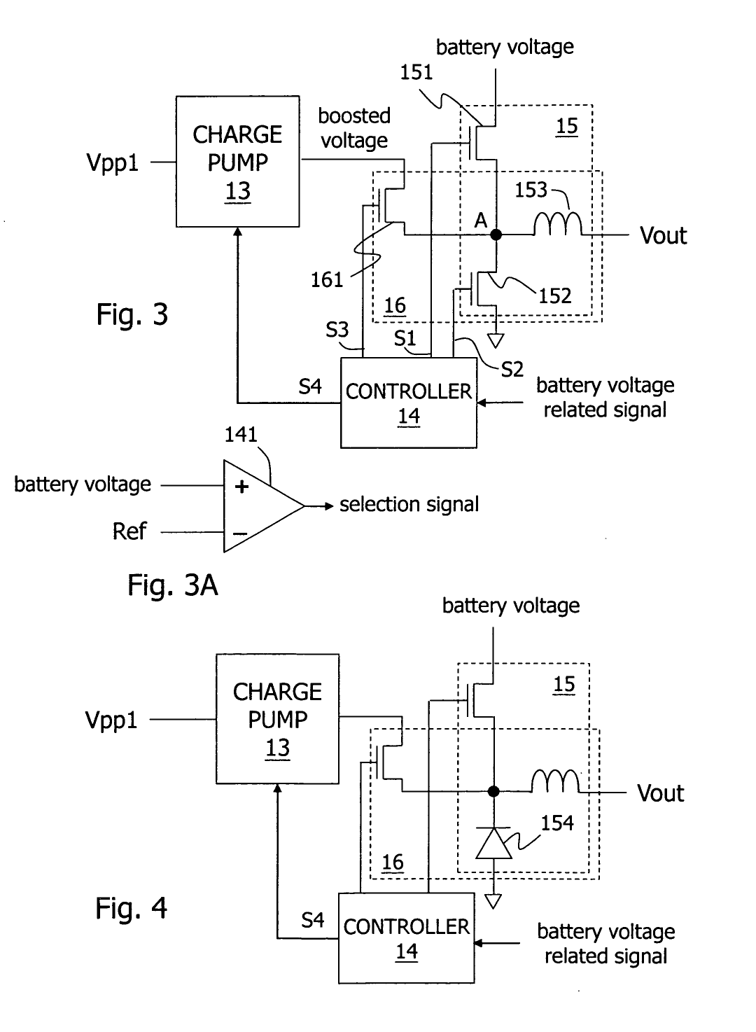

Please refer to FIG. 3 for a first embodiment according to the present invention, which operates as follows: when the battery voltage is higher than a threshold voltage which is high enough to generate an output Vout by buck conversion, the circuit converts the battery voltage to the output voltage Vout through a first buck switching regulator 15. This provides much better power conversion efficiency than the prior art because: first, the buck switching regulator provides better power conversion efficiency than a boost switching regulator; second, the power conversion is performed through only one buck switching regulator instead of being performed through two switching regulators; third, the current goes through a shorter path in a PCB. On the other hand, when the battery voltage decreases to become not higher than the threshold voltage, a charge pump 13 generates a boosted voltage, and a second buck switching regulator 16 converts the boosted voltage to the output voltage Vout. Preferably, the first buck switching regulator 15 and the second buck switching regulator 16 can share some of the power devices to reduce the cost.

In detail, as shown in the figure, when the battery voltage is higher than the threshold voltage, a signal related to the battery voltage (battery voltage related signal) causes a controller 14 to generate a set of signals S1 and S2 for operating a first power transistor 151 and a lower gate transistor 152 to convert the battery voltage to the output voltage Vout, and the controller 14 generates a charge pump control signal S4 to disable the charge pump 13. When the battery voltage is not higher than the threshold voltage, the controller 14 generates the charge pump control signal S4 to enable the charge pump 13 to generate the boosted voltage, and the controller 14 also generates another set of signals S3 and S2 for operating a second power transistor 161 and the lower gate transistor 152 in the second buck switching regulator 16 to convert the boosted voltage to the output voltage Vout. Either the output voltage Vout is generated from the battery voltage or from the boosted voltage, in either case the power conversion is buck conversion, so less power is consumed. In addition, the first buck switching regulator 15 and the second buck switching regulator 16 can share the lower gate transistor 152 and the inductor 153 to save the cost of circuit devices. That is, as shown in the figure, the first buck switching regulator 15 includes the first power transistor 151, the lower gate transistor 152 and the inductor 153 which are coupled to a node A, and the second buck switching regulator 16 includes the second power transistor 161, the lower gate transistor 152 and the inductor 153 which are coupled to the node A.

The boosted voltage is generated by the charge pump 13. In this embodiment, the charge pump 13 receives a voltage Vpp1, and performs a boost operation to generate the boosted voltage which is higher than the output voltage Vout. The charge pump 13 can be any kind of charge pump, such as a fixed or variable multiple charge pump (the multiple is not limited to an integer). The voltage Vpp1 can be generated from any proper voltage, such as a node having a fixed voltage level. Compared with the prior art, the circuit of the present invention provides a much better power utilization efficiency because: first, most of the time only the first buck switching regulator 15 is in operation, and it seldom requires the charge pump 13 and the second buck switching regulator 16 to be in operation; second, the charge pump 13 provides better power conversion efficiency than a boost switching regulator; third, the current goes through a shorter path in a PCB.

There are many ways to detect a level of the battery voltage; FIG. 3A shows an example, wherein a comparator 141 compares the battery voltage (or a signal indicating the battery voltage) with a reference voltage Ref, and outputs a selection signal. The selection signal determines which one of the first buck convert 15 and the second buck switching regulator 16 should operate to generate the output voltage Vout, and also determines whether the charge pump 13 should be enabled.

FIG. 4 shows a second embodiment according to the present invention. Different from the first embodiment, the lower gate transistor 152 is replaced by a diode 154. Similar to the relationship between FIGS. 2A and 2B, the replacement of the lower gate transistor 152 by the diode 154 changes the switching regulators 15 and 16 from synchronous type to asynchronous type. Similar to the first embodiment, the first buck switching regulator 15 and the second buck switching regulator 16 also can share the diode 154.

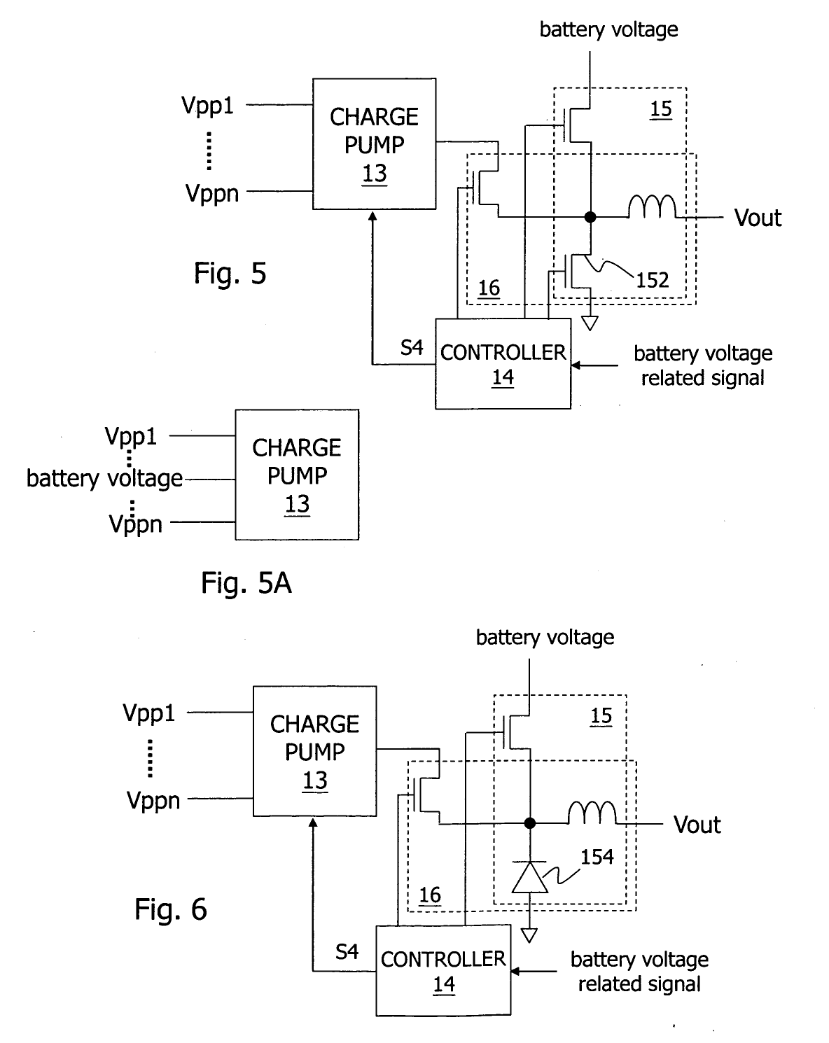

FIG. 5 shows a third embodiment according to the present invention, wherein the charge pump 13 can be a charge pump which generates the boosted voltage by adding multiple voltages, or generates the boosted voltage as a fixed or variable multiple of one voltage. As shown in the figure, the charge pump 13 receives multiple input voltages Vpp1˜Vppn. In one embodiment, the charge pump 13 selects two input voltages from the multiple input voltages Vpp1˜Vppn according to the control signal S4, and adds the selected two input voltages to generate a proper boosted voltage higher than the output voltage Vout. In another embodiment, the charge pump 13 selects one input voltage from the multiple input voltages Vpp1˜Vppn according to the control signal S4, and generates the boosted voltage equal to a multiple of the selected input voltage, wherein the multiple of the selected input is not limited to an integer.

In addition, as shown in FIG. 5A, at least one of multiple input voltages Vpp1˜Vppn received by the charge pump 13 can be directly or indirectly from the battery (i.e., the “battery voltage” shown in the figure).

FIG. 6 shows a fourth embodiment according to the present invention, wherein the charge pump 13 also receives multiple voltages Vpp1˜Vppn. But different from the third embodiment, the lower gate transistor 152 is replaced by the diode 154, which is shared by the first buck switching regulator 15 and the second buck switching regulator 16.

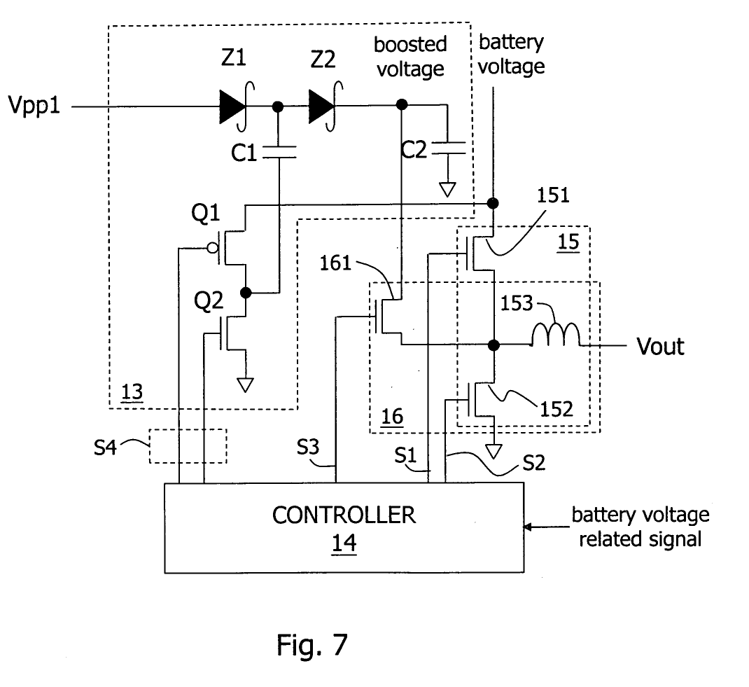

FIG. 7 shows a fifth embodiment according to the present invention, in which one practical embodiment of the charge pump 13 is illustrated. As described above, the charge pump 13 can be embodied in many ways, so FIG. 7 is only one among many possible embodiments and should not be taken as a limitation to the present invention. As shown in the figure, when the battery voltage is higher than the threshold voltage, the battery voltage related signal causes the controller 14 to generate a set of signals S1 and S2 for operating the first power transistor 151 and the lower gate transistor 152 to convert the battery voltage to the output voltage Vout. When the battery voltage is not higher than the threshold voltage, the controller 14 generates the charge pump control signal S4 to enable the charge pump 13 to generate the boosted voltage, and the controller 14 also generates another set of signals S3 and S2 for operating the second power transistor 161 and the lower gate transistor 152 in the second buck switching regulator 16 to convert the boosted voltage to the output voltage Vout. The charge pump 13 in this embodiment corresponds to the structure shown in FIG. 5A, wherein the charge pump 13 receives the voltage Vpp1, the battery voltage, and the control signal S4 from the controller 14. When the battery voltage is not higher than the threshold voltage, the control signal S4 turns on a transistor Q1 and turns off a transistor Q2 so that the battery voltage can charge a capacitor C1 via the transistor Q1, and the voltage across the capacitor C1 and the voltage Vpp1 are added and stored in a capacitor C2. In the circuit, optionally, two zener diodes Z1 and Z2 can be provided to prevent current from flowing through a reverse direction, and in this case the boosted voltage becomes the sum of the battery voltage and the voltage Vpp1 subtracting two forward bias voltages of the zener diodes Z1 and Z2. Thus, when the battery is not higher than the threshold voltage, the circuit can provide a proper boosted voltage to be converted to the output voltage Vout by buck conversion.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, the charge pump 13 can be replaced by any kind of charge pump; a device which does not affect the primary functions of the circuits (such as a switch) can be interposed between two devices or circuits shown to be in direct connection in the illustrated embodiments. As another example, the positive and negative input terminals of a comparator can be swapped as long as corresponding modifications are made so that the input and output signals of the comparator are properly processed to provide a desired function. Thus, the present invention should cover all such and other modifications and variations, which should be interpreted to fall within the scope of the following claims and their equivalents.

What is claimed is:

1. A power supply circuit with adaptive input selection, comprising:
a charge pump receiving at least one voltage and generating a boosted voltage;
a first buck switching regulator coupled to a battery, for operating at least one first power transistor to convert a voltage of the battery to an output voltage according to a first control signal;
a second buck switching regulator coupled to the charge pump, for operating at least one second power transistor to convert the boosted voltage to the output voltage according to a second control signal; and
a controller generating the first control signal or the second control signal according to a level of the voltage of the battery, to select the first buck switching regulator or the second switching regulator for generating the output signal.

2. The power supply circuit of claim 1, wherein the first buck switching regulator and the second buck switching regulator share at least one power device.

3. The power supply circuit of claim 2, wherein the first buck switching regulator includes the first power transistor, a lower gate transistor and an inductor which are coupled to a same node, and the second buck switching regulator includes the second power transistor, the lower gate transistor and the inductor which are coupled to the same node.

4. The power supply circuit of claim 2, wherein the first buck switching regulator includes the first power transistor, a diode and an inductor which are coupled to a same node, and the second buck switching regulator includes the second power transistor, the diode and the inductor which are coupled to the same node.

5. The power supply circuit of claim 1, wherein the charge pump receives the at least one voltage directly or indirectly from the battery.

6. The power supply circuit of claim 5, wherein the charge pump adds the voltage of the battery with another voltage, to generate the boosted voltage.

7. The power supply circuit of claim 1, wherein the charge pump generates the boosted voltage by adding multiple voltages, or generates the boosted voltage as a fixed or variable multiple of one voltage.

8. The power supply circuit of claim 1, wherein when the output voltage is generated by the first buck switching regulator, the charge pump is disabled.

9. A power supply method with adaptive input selection, comprising:
receiving a battery voltage;
converting the battery voltage to an output voltage when the battery voltage is higher than a threshold voltage;
receiving at least one voltage and generating a boosted voltage when the battery voltage is not higher than the threshold voltage; and
converting the boosted voltage to the output voltage.

10. The method of claim 9, wherein the step of converting the battery voltage to an output voltage and the step of converting the boosted voltage to the output voltage share at least one power device.

11. The method of claim 9, wherein the step of receiving at least one voltage and generating a boosted voltage is achieved by a charge pump which generates the boosted voltage by adding multiple voltages, or generates the boosted voltage as a fixed or variable multiple of one voltage.

12. The method of claim 9, wherein the step of receiving at least one voltage and generating a boosted voltage is achieved by adding the battery voltage with another voltage to generate the boosted voltage.

13. The method of claim 11, wherein when the battery voltage is higher than the threshold voltage, the charge pump is disabled.
